(19) United States
(12) Patent Application Publication
(10) Pub. No.: US 2003/0138959 A1
(43) Pub. Date: Jul. 24, 2003

(54) Method of detecting oxidizing adulterants in urine

(76) Inventors: Jesse M. Carter, Tampa, FL (US); Robert L. Immekus, Tampa, FL (US)

Correspondence Address: Jesse M. Carter, P.O. Box 13275, Tampa, FL, 33681, US

(21) Appl. No.: 10/051,845

(22) Filed: Jan. 17, 2002

(51) Int. Cl. G01N 35/00; G01N 21/78

(52) U.S. Cl. 436/43; 436/901; 436/164; 436/171; 422/68.1; 422/82.05; 422/82.09; 422/63

(57) ABSTRACT

This invention relates to a reagent for use in determining the presence of oxidizing adulterants in urine being screened for drugs of abuse. This invention is useful in automated spectrophotometric analyzers used in screening urine for drugs of abuse.

### PRIOR APPLICATIONS

None. This application is filed Nov. 16, 2000.

### BACKGROUND OF INVENTION

This invention relates to a reagent for use in determining the presence of oxidizing adulterants in urine being screened for drugs of abuse. This invention is useful in automated spectrophotometric analyzers used in screening urine for drugs of abuse.

Analysis of urine for drugs of abuse in the workplace is now routine in industries such as public transportation, military, nuclear plants, and athletics. Because of the consequences of a confirmed-positive workplace drug test, the urine donor may attempt to conceal illegal drug use. The intent of the donor who is trying to subvert the drug testing procedure is to create a false-negative test result through specimen tampering by dilution, substitution, or adulteration by addition. Adulteration by dilution involves diluting any drug present in a urine sample to a level below the concentration required to call it positive. Note, SAMHSA regulations specifically define a positive result as equal to or above a cutoff concentration. This cutoff value is well above the lower limit of detection for the assay. Thus a sample may have some drug present, but not enough to define it as positive. Dilution can take on 2 forms: “in vivo” or “in vitro”. The “in vitro” method is simply addition of water to the urine sample. The “in vivo” method requires internal dilution. The test subject must drink a large amount of water, thereby increasing the water content of the test sample while the amount of drug excreted into the urine is static (i.e., the body removes drug from the blood at a constant rate unaffected by the amount of fluid consumed). Substitution is the use of another person's “clean” urine or other liquid for the test subject's own sample. Urine adulteration by addition requires adding chemicals to the urine to mask the presence of the illicit drug by interfering with the method of drug analysis.

If undetected, false-negative results due to tampering undermine the public's confidence in the drug-testing programs.

The Substance Abuse and Mental Health Services Administration (SAMHSA) of the U.S. Department of Health and Human Services (HHS) issued a Public Health Service notice, “Guidance for Reporting Specimen Validity Test Results”, PD 035, dated Sep. 28, 1998. This notice provides guidance for all laboratories in determining the validity of a specimen.

Under A.2., “Definitions” the document defines a sample as “Adulterated” if 2.c. “the nitrite concentration is equal to or greater than 500 μg/mL, if 2.d. “the pH is equal to or less than 3.0 or equal to or greater than 11.0, if 2.e. “an endogenous substance (i.e., a substance which is not a normal constituent of urine) or an endogenous substance at a higher concentration than normal physiological concentration is present in the specimen.”

A number of commercial products, some sold as drug test adulterants, contain an oxidizing chemical which effectively interferes with tests for illicit drugs resulting in false-negatives or questionable results. These include household bleach, nitrite, chromate, iodates, and peroxidase. Household bleach contains sodium hypochlorite. The article by Caroline Baiker, “Hypochlorite Adulteration of Urine causing Decreased Concentration of Δ⁹-THC-COOH by GC/MS.”, J. Anal. Toxicol., Vol 18, 1994, describes the effects of bleach. Products made and sold for the purpose of drug test adulteration include the product “Klear” which contains nitrite. ElSohly's “A Procedure to Overcome Interferences Caused by the Adulterant Klear in the GC/MS Analysis of 11-Nor Δ⁹-THC-COOH.”, J. Anal. Toxicol., Vol. 21:240-242, 1997, discusses nitrite use. The adulteration product “URINE LUCK”, (formula 5.6) contains pyridinium chlorochromate. The publication of Wu, Alan H. B., et al, “Adulteration of Urine by Urine Luck”, Clin. Chem., Vol. 45:7, 1051-1057, 1999 describes the effects of chromate on drug tests.

Another commercial product “Stealth” contains the oxidizing enzyme peroxidase and its substrate peroxide. Yet another commercial adulterant, “Stealth 51”, contains potassium iodate. Other methods of adulteration by addition include alteration of the urine pH with acids or bases. A method for determination of abnormal urine pH in Smith U.S. Pat. No. 5,801,060 would not impact this proposed art because the Smith reaction is based on determination of pH using acidic and basic color indicators and does not measure oxidants present in urine. Addition can also include compounds such as sodium chloride to increase the ionic strength of the urine and thereby interfere with the enzyme drug assay. The Smith U.S. Pat. No. 5,763,451 is a method of determination of specific gravity based upon the detection of cations and correlates this ionic strength to specific gravity but does not measure oxidants in urine. Other additions include compounds which poison the enzymes used in the assay process (e.g., glutaraldehyde or soaps). Other prior art which discloses a method for identifying adulterants in urine includes Smith U.S. Pat. No. 5,464,775 on the Determination of the Adulterant Glutaraldehyde in Urine. This art is based on chemical reaction with primary ketones and would not measure the concentrations of oxidants present in urine.

A need therefore exists for a stable, liquid, calorimetric, quantitative method to determine the presence of oxidants in urine specimens submitted for drugs of abuse testing that utilizes the current generation of automated analyzers.

### SUMMARY OF THE INVENTION

The present invention relates to a reagent to detect the presence of oxidizing chemicals in urine and is designed for use on automated spectrophotometric analyzers used for drugs of abuse testing and facilitates the simultaneous analysis of the sample for the presence of illicit drugs and an oxidizing adulterant.

The purpose of this art is to rapidly and easily detect the presence of oxidants such as bleach, nitrite, chromate, iodic acid, iodates, peroxide/peroxidase, and others in a urine sample submitted for drugs of abuse analysis. The presence of oxidants in a urine represent a direct attempt to mask drugs in a urine sample, and thereby maintain one's employment. Federally mandated drug testing regulations now require immediate dismissal, if an adulterated sample is submitted for testing.

The instant invention, the oxidant detection reagent, comprises an aqueous solution of buffers, and a phenylamine indicator that yield a color change upon autocatalytic reaction with oxidizers. This color change equates to a change in absorbance as measured by a uv-visible spectrophotometer at a specific wavelength. The magnitude of the change in absorbance corresponds to the concentration of the oxidant present in the urine sample. The phenylamine indicator must be in an acidic solution or it will autocatalyze. Furthermore, the addition of potassium iodide will greatly enhance the reaction with adulterants containing halides such as bleach, and iodic acid when these oxidants are put in a urine matrix versus plain water. Nearly all oxidants are easily stabilized in water; converesly most are not stable in urine.

### DETAILED DESCRIPTION OF THE INVENTION

The instant invention described herein and used to identify adulteration by detection of oxidants in urine samples submitted for drugs of abuse testing comprises an aqueous solution of buffered phenylamine indicator.

More precisely described, the invention is an automated method for detecting the presence of oxidants in a urine sample comprising placing an aliquot of the urine in a first automated analyzer sample cup, placing a standard of known concentration of oxidant in a second automated analyzer sample cup, placing the cups in a sample tray within the automated analyzer, transferring the urine from the first sample cup and the standard from the second sample cup to discrete cuvettes mounted within the automated analyzer, injecting an aqueous reagent composition comprising an acid at 0.01 N concentration or higher and one or more phenylamine chromogenic indicators from the group consisting of

N,N,N,N-tetramethyl-1,4-phenylenediamine, N,N-diethyl-1,4,-phenylenediamine, 2,3,5,6-tetramethyl-1,4-phenylenediamine, N,N-dimethyl-p-phenylenediamine, 2,4,6-trimethyl-1,3-phenylenediamine, N,N,N,N-tetramethylbenzidine,

3,3,5,5-tetramethylbenzidine, N,N,N,N-tetramethyl-4,4-diaminestilbene and O-tolidine.

into cuvettes and mixing and determining the sample-reagent mixture's absorbance with the automated analyzer's spectrophotometer at a preprogrammed wavelength between 400 and 700 nm at a preprogrammed time between 12 seconds and 600 seconds after the phenylamine chromogenic indicator is added to the cuvettes and comparing the absorbance of the urine-reagent mixture to the absorbance of the standard-reagent mixture and thereby determining if the sample has an abnormal amount of oxidant compound present. The reagent may also contain potassium iodide to enhance sensitivity to bleach and iodine containing oxidants. This enhanced sensitivity is important because bleach and some other halides will bind to nitrogen containing compounds in urine.

Nitrogenous compounds are typically found in urine and include urea, uric acid, and proteins. Bleach in particular will bind to these compounds very quickly (less than 4 hours). Potassium iodide greatly enhances the reactivity of bound bleach with phenylamines.

Because most urine specimens tested in SAMHSA certified labs are 8 to 48 hours old, any urine sample adulterated with very low concentration of bleach (less than 5% vol. to vol.) might not have any free bleach when tested. Therefore, the quantity of bleach added to a specimen would have to exceed the concentration of nitrogen-containing compounds in the urine sample in order to have free bleach to react with the phenylamine compound and produce a color.

A healthy adult will void approximately 1000 to 2000 mL of urine per 24 hours. A healthy adult will excrete 25 to 43 grams of urea per 24 hours. Therefore, on average, a healthy adult's urine sample will contain 1.25 g of urea/dL or 20.8 mM/dL. Therefore, an average urine sample has a minimum binding capacity of 20.8 mM/dL of beach. Based on typical commercially available bleach (51/4% sodium hypochlorite) a 28% bleach spike (vol. to vol.) would be 100% bound to the urea in an average sample. As previously noted bleach spikes as low as 0.5% (See Baker, et. al.) can effectively adulterate a urine sample with drugs present.

Surfactants can also be added to increase solubility of reagent components, decrease surface tension in the sample-reagent mixture, and improve flow kinetics through the tubing of the automated analyzer.

In order to prevent autocatalysis and produce a stable reagent the aqueous solution containing the phenylamine indicator must be acidified. If potassium iodide is included to improve reagent reactivity with oxidants such as bleach, it must be stabilized as well. Potassium iodide will break down to elemental iodine in water.

The addition of sodium hydroxide will prevent this. The reaction between the target oxidants (nitrite, chromate, bleach, peroxide, iodate, iodic acid, etc.,) must occur at a weakly acidic pH. The ideal pH for the final reaction mixture is 5.0 to 6.0. Because the two parts of the reagent composition are at pH extremes the formulation must combine to produce this ideal final pH without being impacted by the pH and buffering capactity of the urine specimen.

This oxidant-detecting reagent is placed in the auto-analyzer along with samples and standards to be analyzed. The instrument aliquots samples into individual cuvettes, adds reagent, and measures the absorbance of each test sample at a specific wavelength and compares these absorbance readings to that of a known standard to determine the presence or absence of oxidants.

More precisely described, the invention is an automated method for detecting the presence of oxidants in a urine sample comprising placing an aliquot of the urine in a first automated analyzer sample cup, placing a standard of known concentration of oxidant in a second automated analyzer sample cup, placing the cups in a sample tray within the automated analyzer, transferring the urine from the first sample cup and the standard from the second sample cup to discrete cuvettes mounted within the automated analyzer, injecting a first aqueous reagent composition comprising potassium iodide and one or more buffering compounds into the cuvettes, injecting a second aqueous reagent composition comprising an acid at 0.01 N concentration or higher and one or more phenylamine chromogenic indicators from the group consisting of N,N,N,N-tetramethyl-1,4-phenylenediamine,

N,N-diethyl-1,4,-phenylenediamine, 2,3,5,6-tetramethyl-1,4-phenylenediamine,

N,N-dimethyl-p-phenylenediamine, 2,4,6-trimethyl-1,3-phenylenediamine,

N,N,N,N-tetramethylbenzidine, 3,3,5,5-tetramethylbenzidine,

N,N,N,N-tetramethyl-4,4-diaminestilbene and O-tolidine into the cuvettes and mixing

and determining the sample-reagent mixture's absorbance with the automated analyzer's spectrophotometer at a preprogrammed wavelength between 400 and 700 nm at a preprogrammed time between 12 seconds and 600 seconds after the phenylamine chromogenic indicator is added to the cuvettes and, comparing the absorbance of the urine-reagent mixture to the absorbance of the standard-reagent mixture and thereby determining if the sample has an abnormal amount of oxidant compound present.

The following formulations represent examples of oxidant-detecting reagents.

### EXAMPLE I

Prepare a liter of solution containing:

| | |
|---|---|
| A. 0.25 g | O-Toludine Hydrochloric acid |
| B. 8.3 mLs | Hydrochloric Acid |

C. QS with water to make 1 liter.

This formulation is added to samples at a ratio of 15 to 1 (e.g., 20 μL sample to 300 μL reagent). This assay would be calibrated with chromate as the standard (25 μg/mL Cr) and absorbance measured at 415 nm. This formulation has good sensitivity to nitrites, chromate, and peroxide/peroxidase, but not to low levels of bleach and iodic acid. One could include 1.0 mL of Brij-30 per liter of reagent.

### Typical Hitachi 717 Parameters for the Oxidant Assay

| ASSAY CODE | 1 POINT [15]-[0] |
|---|---|
| SAMPLE VOLUME | [20] |
| R1 VOLUME | [300] [100] [NO] |
| R2 VOLUME | [0] [100] [NO] |
| WAVE LENGTH | [ ] [415] |
| CALIBRATOR METHOD | [LINEAR] [0] [0] |
| STD (1) CONC. POS | [0]-[−] |
| STD (2) CONC. POS | [25]-[−] |
| UNITS | [mg/dL] |
| SD LIMIT | [999] |
| DUPLICATE LIMIT | [32000] |
| SENSITIVITY LIMIT | [0] |
| ABS. LIMIT | [32000] [INCREASE] |
| PROZONE LIMIT | [0] [UPPER] |
| EXPECTED VALUE | [0]-[1000] |
| TECH LIMIT | [0]-[1000] |
| INSTRUMENT FACTOR | [1.0] |

### EXAMPLE II

Prepare a solution containing:

R1

| | |
|---|---|
| a) 0.6 g | Potassium Iodide |
| b) 10 mLs | 1.0 N Sodium Hydroxide |

c) QS to 1 liter with water.

R2

| | |
|---|---|
| a) 0.30 g | O-Toludine-Hydrochloric Acid |
| b) 100 mLs | 1.0 N Galcial Acetic Acid |

c) QS to 1 liter with water

This formulation is added to samples at a ratio of 1 to 7½ to 7½ (e.g., 20 μL to 150 μL to 150 μL). This assay would be calibrated with nitrite standard 200 mg/L and absorbance measured at 600 nm. This formula has good sensitivity to bleach, nitrite, chromates, and peroxide/peroxidase and moderate sensitivity to bleach and iodic acid. The potassium iodide acts to intensify the reactivity of bleach and iodic acid.

### Typical Hitachi 717 Parameters for the Oxidant Assay

| ASSAY CODE | 1 POINT [15]-[0] |
|---|---|
| SAMPLE VOLUME | [20] |
| R1 VOLUME | [150] [100] [NO] |
| R2 VOLUME | [150] [100] [NO] |
| WAVE LENGTH | [ ] [600] |
| CALIBRATOR METHOD | [LINEAR] [0] [0] |
| STD (1) CONC. POS | [0]-[−] |
| STD (2) CONC. POS | [200]-[−] |
| UNITS | [mg/dL] |
| SD LIMIT | [999] |
| DUPLICATE LIMIT | [32000] |
| SENSITIVITY LIMIT | [0] |
| ABS. LIMIT | [32000] [INCREASE] |
| PROZONE LIMIT | [0] [UPPER] |
| EXPECTED VALUE | [0]-[1000] |
| TECH LIMIT | [0]-[1000] |
| INSTRUMENT FACTOR | [1.0] |

### EXAMPLE III

Prepare a solution containing:

R1

| | |
|---|---|
| a) 8.0 g | Potassium Iodide |
| b) 9.9 g | Sodium Acetate |
| c) 10.0 mLs | 1.0 N Sodium Hydroxide |

d) QS to 1 liter with water.

R2

| | |
|---|---|
| a) 9.0 g | DEPD (Diethyl-1,4-phenylenediamine sulfate) |
| b) 10.0 mLs | 1.0 N Hydrochloric Acid |

c) QS to 1 liter with water.

This formulation is added to samples at a ratio of 1 to 7½ to 6¼ (e.g. 20 μL to 150 μL to 125 μL). This assay would be calibrated with 150 mg/L of nitrite standard and absorbance measured at 546 nm. This formula has good sensitivity to bleach, nitrite, chromate, iodate/iodic acid, and peroxide/peroxidase. The potassium iodide acts to intensify the reactivity of bleach and iodic acid.

### Typical Hitachi 717 Parameters for the Oxidant Assay

| ASSAY CODE | 1 POINT [15]-[0] |
|---|---|
| SAMPLE VOLUME | [20] |
| R1 VOLUME | [150] [100] [NO] |
| R2 VOLUME | [125] [100] [NO] |
| WAVE LENGTH | [ ] [546] |
| CALIBRATOR METHOD | [LINEAR] [0] [0] |
| STD (1) CONC. POS | [0]-[−] |
| STD (2) CONC. POS | [200]-[−] |
| UNITS | [mg/dL] |
| SD LIMIT | [999] |
| DUPLICATE LIMIT | [32000] |
| SENSITIVITY LIMIT | [0] |
| ABS. LIMIT | [32000] [INCREASE] |
| PROZONE LIMIT | [0] [UPPER] |
| EXPECTED VALUE | [0]-[1000] |
| TECH LIMIT | [0]-[1000] |
| INSTRUMENT FACTOR | [1.0] |

### EXAMPLE IV

Prepare a solution containing:

R1

| | |
|---|---|
| a) 11.75 g | Potassium Iodide |
| b) 34.0 g | Sodium Acetate |
| c) 2.94 mLs | 5.0 N Sodium Hydroxide |

d) QS to 1 liter with water.

R2

| | |
|---|---|
| a) 0.1 g | DEPD (Diethyl-1,4-phenylenediamine sulfate) |
| b) 0.333 g | N,N,N,N-Tetramethyl-1,4- |
| | phenylenediaminedihydrochloride |
| c) 6.9 mLs | Phosphoric Acid |

d) QS to 1 liter with water.

This formulation is added to samples at a ratio of 1 to 7 to 7 (e.g. 18 μL to 130 μL to 130 μL). This assay would be calibrated with 150 mg/L of nitrite standard and absorbance measured at 570 nm. This formula has good sensitivity to bleach, nitrite, chromate, iodate/iodic acid, and peroxide/peroxidase. The potassium iodide acts to intensify the reactivity of bleach and iodic acid.

### Typical Hitachi 717 Parameters for the Oxidant Assay

| ASSAY CODE | 1 POINT [37]-[0] |
|---|---|
| SAMPLE VOLUME | [18] |
| R1 VOLUME | [130] [100] [NO] |
| R2 VOLUME | [130] [100] [NO] |
| WAVE LENGTH | [ ] [570] |
| CALIBRATOR METHOD | [LINEAR] [0] [0] |
| STD (1) CONC. POS | [0]-[−] |
| STD (2) CONC. POS | [150]-[−] |
| UNITS | [mg/dL] |
| SD LIMIT | [999] |
| DUPLICATE LIMIT | [32000] |
| SENSITIVITY LIMIT | [0] |
| ABS. LIMIT | [32000] [INCREASE] |
| PROZONE LIMIT | [0] [UPPER] |
| EXPECTED VALUE | [0]-[1000] |
| TECH LIMIT | [0]-[1000] |
| INSTRUMENT FACTOR | [1.0] |

### EXAMPLE V

Prepare a liter of solution containing:

| | |
|---|---|
| A. 0.25 g | N,N,N,N-tetramethylbenzidine |
| B. 50 mLs | 5 N Hydrochloric Acid |

C. QS with water to make 1 liter.

This formulation is added to samples at a ratio of 13 to 1 (e.g., 15 μL sample to 200 μL reagent). This assay would be calibrated with nitrite as the standard (200 mg/mL Nitrite) and absorbance measured at 415 nm. This formulation has good sensitivity to nitrites, chromate, and peroxide/peroxidase, but not to low levels of bleach and iodic acid. One could include 1.0 mL of Brij-30 per liter of reagent.

### Typical Hitachi 717 Parameters for the Oxidant Assay

| ASSAY CODE | 1 POINT [15]-[0] |
|---|---|
| SAMPLE VOLUME | [15] |
| R1 VOLUME | [200] [100] [NO] |
| R2 VOLUME | [0] [100] [NO] |
| WAVE LENGTH | [ ] [415] |
| CALIBRATOR METHOD | [LINEAR] [0] [0] |
| STD (1) CONC. POS | [0]-[−] |
| STD (2) CONC. POS | [200]-[−] |
| UNITS | [mg/dL] |
| SD LIMIT | [999] |
| DUPLICATE LIMIT | [32000] |
| SENSITIVITY LIMIT | [0] |
| ABS. LIMIT | [32000] [INCREASE] |
| PROZONE LIMIT | [0] [UPPER] |
| EXPECTED VALUE | [0]-[1000] |
| TECH LIMIT | [0]-[1000] |
| INSTRUMENT FACTOR | [1.0] |

### REFERENCES

Public Health Service notice, “Guidance for Reporting Specimen Validity Test Results”, PD 035, Sep. 28, 1998.

Caroline Baiker, Leo Serrano and Becky Linder. “Hypochlorite Adulteration of Urine Causing Decreased Concentration of Δ⁹-THC-COOH by GC/MS.”, J. Anal. Toxicol., Vol. 18:101-103. 1994.

ElSohly, M. A. et,al. “A Procedure to Overcome Interferences Caused by the Adulterant “Klear” in the GC/MS Analysis of 11--Nor Δ⁹-THC-COOH.”, J. Anal. Toxicol., Vol. 21:240-242, 1997

Wu, Alan H. B., et al, “Adulteration of Urine by Urine Luck”, Clin. Chem., Vol. 45:7, 1051-1057, 1999.

Smith U.S. Pat. No. 5,801,060 pH

Smith U.S. Pat. No. 5,753,451 specific gravity

Smith U.S. Pat. No. 5,464,775 Determination of the Adulterant Glutaraldehyde in Urine.

I claim:

1 1) an automated method for detecting the presence of oxidants in a urine sample comprising
a) placing an aliquot of the urine in a first automated analyzer sample cup
b) placing a standard of known concentration of oxidant in a second automated analyzer sample cup
c) placing the cups in a sample tray within the automated analyzer, transferring the urine from the first sample cup and the standard from the second sample cup to discrete cuvettes mounted within the automated analyzer, injecting an aqueous reagent composition comprising an acid at 0.01 N concentration or higher and one or more phenylamine chromogenic indicators from the group consisting of N,N,N,N-tetramethyl-1,4-phenylenediamine, N,N-diethyl-1,4,-phenylenediamine, 2,3,5,6-tetramethyl-1,4-phenylenediamine, N,N-dimethyl-p-phenylenediamine, 2,4,6-trimethyl-1,3-phenylenediamine, N,N,N,N-tetramethylbenzidine, 3,3,5,5-tetramethylbenzidine, N,N,N,N-tetramethyl-4,4-diaminestilbene and O-tolidine into cuvettes and mixing
d) determining the sample-reagent mixture's absorbance with the automated analyzer's spectrophotometer at a preprogrammed wavelength between 400 and 700 nm at a preprogrammed time between 12 seconds and 600 seconds after the phenylamine chromogenic indicator is added to the cuvettes and
e) comparing the absorbance of the urine-reagent mixture to the absorbance of the standard-reagent mixture and thereby determining if the sample has an abnormal amount of oxidant compound present.

2 1) an automated method for detecting the presence of oxidants in a urine sample comprising
a) placing an aliquot of the urine in a first automated analyzer sample cup
b) placing a standard of known concentration of oxidant in a second automated analyzer sample cup
c) placing the cups in a sample tray within the automated analyzer, transferring the urine from the first sample cup and the standard from the second sample cup to discrete cuvettes mounted within the automated analyzer, injecting a first aqueous reagent composition comprising potassium iodide and one or more buffering compounds into the cuvettes
d) injecting a second aqueous reagent composition comprising an acid at 0.01 N concentration or higher and one or more phenylamine chromogenic indicators from the group consisting of N,N,N,N-tetramethyl-1,4-phenylenediamine, N,N-diethyl-1,4,-phenylenediamine, 2,3,5,6-tetramethyl-1,4-phenylenediamine, N,N-dimethyl-p-phenylenediamine, 2,4,6-trimethyl-1,3-phenylenediamine, N,N,N,N-tetramethylbenzidine, 3,3,5,5-tetramethylbenzidine, N,N,N,N-tetramethyl-4,4-diaminestilbene and O-tolidine into the cuvettes and mixing and
e) determining the sample-reagent mixture's absorbance with the automated analyzer's spectrophotometer at a preprogrammed wavelength between 400 and 700 nm at a preprogrammed time between 12 seconds and 600 seconds after the phenylamine chromogenic indicator is added to the cuvettes and
f) comparing the absorbance of the urine-reagent mixture to the absorbance of the standard-reagent mixture and thereby determining if the sample has an abnormal amount of oxidant compound present.

3 The process according to claim #1 wherein the phenylamine chromogenic indicators include one or more of the following group:
N,N,N,N-tetramethyl-1,4-phenylenediamine, N,N-diethyl-1,4,-phenylenediamine,
2,3,5,6-tetramethyl-1,4-phenylenediamine, N,N-dimethyl-p-phenylenediamine,
2,4,6-trimethyl-1,3-phenylenediamine, N,N,N,N-tetramethylbenzidine,
3,3,5,5-tetramethylbenzidine, N,N,N,N-tetramethyl-4,4-diaminestilbene and O-tolidine.

4 The process according to claim #1 wherein the acid is a mineral acid from the following group: hydrochloric acid, phosphoric acid, sulfuric acid, glacial acetic acid, and perchloric acid.

5 The process according to claim #1 wherein the indicator is N,N,N,N-tetramethylbenzidine in 0.25 N hydrochloric acid and the wavelength is 415, and the read time is 60 seconds.

6 The process according to claim #2 wherein the phenylamine chromogenic indicators include one or more of the following group:
N,N,N,N-tetramethyl-1,4-phenylenediamine,
N-N-diethyl-1,4,-phenylenediamine, 2,3,5,6-tetramethyl-1,4-phenylenediamine,
N,N-dimethyl-p-phenylenediamine, 2,4,6-trimethyl-1,3-phenylenediamine,
N,N,N,N-tetramethylbenzidine, 3,3,5,5-tetramethylbenzidine,
N,N,N,N-tetramethyl-4,4-diaminestilbene and O-tolidine.

7 The process according to claim #2 wherein the acid is a mineral acid from the following group: hydrochloric acid, phosphoric acid, sulfuric acid, glacial acetic acid, and perchloric acid.

8 The process according to claim #2 wherein sodium iodide is substituted for potassium iodide.

9 The process according to claim #2 wherein buffers include sodium hydroxide, sodium acetate, aminomethyl propanol, barbitol, borate, bicine, bis-tris-propane, carbonate, CAPS, Glycine, MOPSO, phosphate, POPSO, TABS, and TRIS.

10 The process according to claim #2 wherein the first aqueous reagent composition consists of potassium iodide, sodium acetate, and sodium hydroxide and the second aqueous reagent composition consists of N,N-diethyl-1,4-phenylenediamine sulfate, N,N,N,N-tetramethyl-1,4-phenylenediamine and hydrochloric acid.
